(19) United States
(12) Patent Application Publication
(10) Pub. No.: US 2023/0349385 A1
(43) Pub. Date: Nov. 2, 2023

(54) ROTATING MACHINE AND TURBOCHARGER INCLUDING THE SAME

(71) Applicant: BorgWarner Inc., Auburn Hills, MI (US)

(72) Inventors: John Robert ZAGONE, Hendersonville, NC (US); Robert Malcolm WALLACE, Candler, NC (US); Kevin John FOGARTY, Arden, NC (US); Samuel Whitney WELDON, Hendersonville, NC (US)

(21) Appl. No.: 18/305,110

(22) Filed: Apr. 21, 2023

Related U.S. Application Data
(60) Provisional application No. 63/336,146, filed on Apr. 28, 2022.

(51) Int. Cl. F04D 29/42; F02B 37/00; F04D 17/10; F04D 29/28

(52) U.S. Cl. CPC F04D 17/10; F02B 37/00; F04D 29/284; F04D 29/4206

(57) ABSTRACT

A rotating machine for delivering a working fluid to a system includes a compressor housing defining a compressor housing interior and partially defining a flow path. The rotating machine also includes a shaft and a compressor wheel disposed in the compressor housing interior. The rotating machine additionally includes a backplate coupled to the compressor housing and further defining the flow path. The backplate and the compressor housing are configured to direct working fluid from the compressor housing interior through the flow path. The backplate defines a working fluid connection adjacent the compressor wheel and/or the flow path such that the working fluid connection is fluidly coupled to the flow path and such that the compressor wheel delivers working fluid from the compressor housing interior and the working fluid connection to the flow path.

### CROSS-REFERENCE TO RELATED APPLICATIONS

This application claims priority pursuant to 35 U.S.C. 119(a) to subject U.S. Provisional Pat. Application No. 63/336,146, filed on Apr. 28, 2022, which application is incorporated herein by reference in its entirety.

### FIELD OF THE DISCLOSURE

The present disclosure generally relates to a rotating machine and, more specifically, to a turbocharger including the rotating machine.

### BACKGROUND AND RELATED ART

Rotating machines, such as turbochargers, electric compressors, and the like, are used in various applications, such as vehicles, heavy equipment, diesel engines, motors, and cooling systems. Rotating machines are used, for example, to increase power output of an internal combustion engine, lower fuel consumption of an internal combustion engine, and reduce emissions produced by an internal combustion engine. Delivery of compressed air to the internal combustion engine by the rotating machine allows the internal combustion engine to be smaller, yet able to develop the same or similar amount of horsepower as larger, naturally aspirated internal combustion engines. Having a smaller internal combustion engine for use in a vehicle reduces the mass and aerodynamic frontal area of the vehicle, which helps reduce fuel consumption of the internal combustion engine and improve fuel economy of the vehicle.

Typical rotating machines include a compressor housing defining a compressor housing interior. Typical compressor housings partially define a flow path fluidly coupled to the compressor housing interior for directing compressed air to the internal combustion engine through the flow path. Conventional rotating machines also include a shaft and a compressor wheel. The compressor wheel is disposed in the compressor housing interior and coupled to the shaft, with the compressor wheel being rotatable by the shaft. Typical compressor wheels have an inducer and an exducer, with the exducer of the compressor wheel being configured to deliver air from the compressor housing interior to the flow path during rotation of the compressor wheel. Typical rotating machines also include a backplate coupled to the compressor housing and further defining the flow path, with the backplate and the compressor housing being configured to direct compressed air from the compressor housing interior through the flow path and to the internal combustion engine.

In recent years, there has been a desire to increase the efficiency and overall performance of rotating machines, such as optimizing surge line locations and improving efficiency in portions of compressor maps, which, in turn, results in a more efficient and better performing rotating machine.

As such, there remains a need to provide an improved rotating machine.

### SUMMARY OF THE INVENTION

A rotating machine for delivering a working fluid to a system includes a compressor housing defining a compressor housing interior extending between a first compressor housing end and a second compressor housing end. The compressor housing partially defines a flow path fluidly coupled to the compressor housing interior for directing working fluid to the system through the flow path. The compressor housing extends along a compressor housing axis between the first and second compressor housing ends. The rotating machine also includes a shaft extending along a shaft axis parallel with the compressor housing axis. The rotating machine further includes a compressor wheel disposed in the compressor housing interior, with the compressor wheel being coupled to the shaft and rotatable by the shaft about the shaft axis. The compressor wheel has an inducer adjacent the first compressor housing end and an exducer adjacent the second compressor housing end. The exducer of the compressor wheel is configured to deliver working fluid from the compressor housing interior to the flow path during rotation of the compressor wheel about the shaft axis. The rotating machine additionally includes a backplate coupled to the compressor housing and further defining the flow path. The backplate and the compressor housing are configured to direct working fluid from the compressor housing interior through the flow path. The backplate defines a working fluid connection adjacent the compressor wheel and/or the flow path such that the working fluid connection is fluidly coupled to the flow path and such that the compressor wheel delivers working fluid from the compressor housing interior and the working fluid connection to the flow path.

### BRIEF DESCRIPTION OF THE DRAWINGS

Other advantages of the present invention will be readily appreciated, as the same becomes better understood by reference to the following detailed description when considered in connection with the accompanying drawings.

FIG. 1A is a cross-sectional view of a rotating machine including a compressor housing defining a compressor housing interior and partially defining a flow path, a shaft, a compressor wheel disposed in the compressor housing interior, with the compressor wheel having an inducer and an exducer, and a backplate coupled to the compressor housing and further defining the flow path, and with the backplate defining a working fluid connection.

FIG. 1B is a cross-sectional view a turbocharger including the rotating machine, with the turbocharger including a turbine housing defining a turbine housing interior, and a turbine wheel disposed within the turbine housing interior for receiving the exhaust gas from an internal combustion engine, with the shaft being coupled to and rotatable by the turbine wheel.

FIG. 2 is a cross-sectional view of a backplate volute of the backplate.

FIG. 3 is a perspective view of the backplate volute.

FIG. 4 is a back view of the backplate.

FIG. 5 is a front view of the backplate.

FIG. 6A is a cross-sectional view of rotating machine, with the working fluid connection directing working fluid into the flow path from the backplate volute.

FIG. 6B is a cross-sectional view of the rotating machine and another embodiment of the working fluid connection, with the working fluid connection directing working fluid into the flow path from the backplate volute.

FIG. 7 is an exploded view of a test setup of the rotating machine.

FIG. 8 is a cross-sectional view of the rotating machine.

FIG. 9 is a perspective view of a valve and a second valve for controlling working fluid flow to and/or from the backplate volute, through the working fluid connection, and into the flow path.

FIG. 10 is a graph representing compressor efficiency as a function of corrected compressor mass flow and compressor pressure ratio.

FIG. 11 is another graph representing compressor efficiency as a function of corrected compressor mass flow and compressor pressure ratio.

FIG. 12 is another graph representing compressor efficiency as a function of corrected compressor mass flow and compressor pressure ratio.

### DETAILED DESCRIPTION OF THE INVENTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

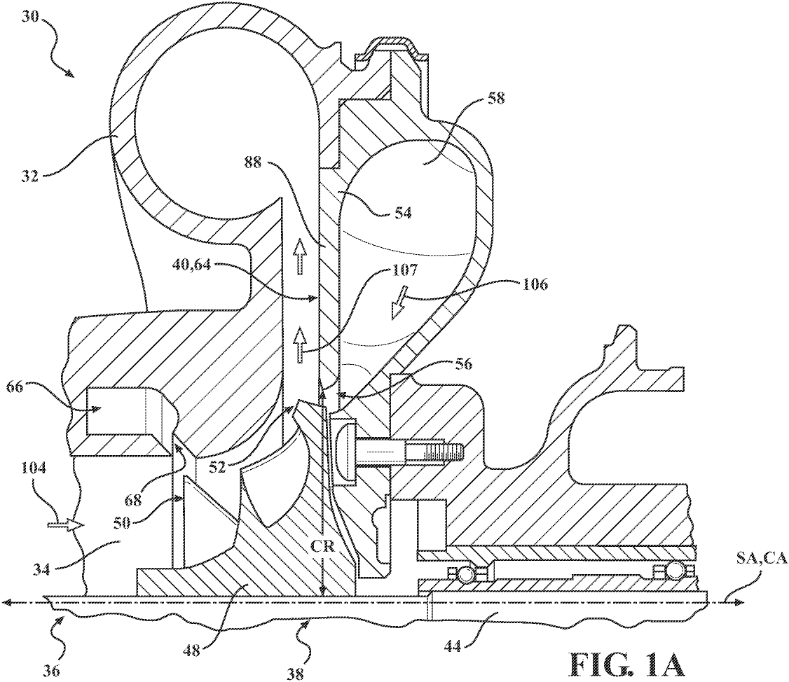

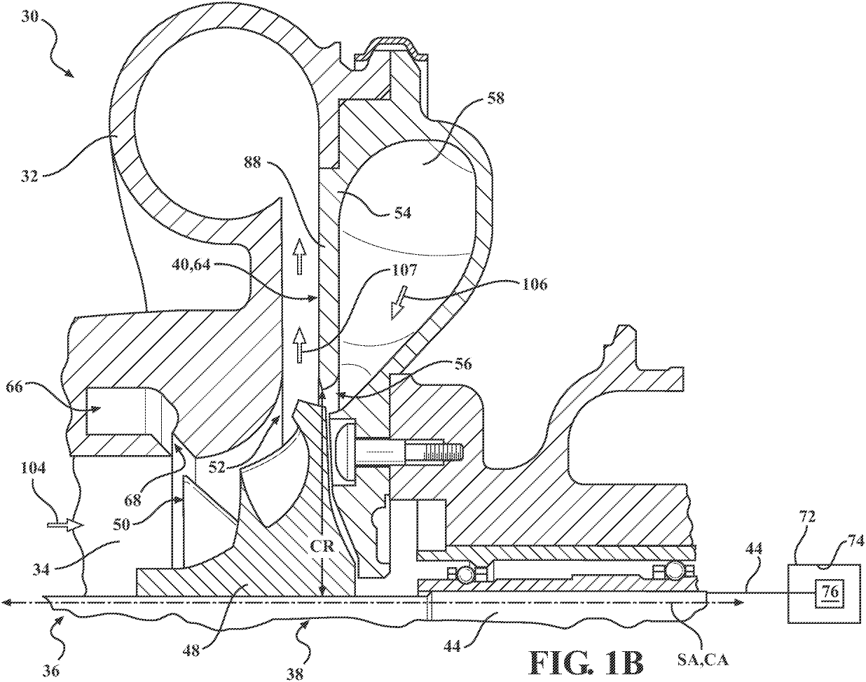

A rotating machine 30 is generally shown in FIG. 1A. The rotating machine 30 may be a mechanical or electric compressor, a supercharger, a turbocharger 70, as shown in FIG. 1B, and the like. The rotating machine 30 typically delivers a working fluid to a system utilizing a working fluid. Examples of systems utilizing a working fluid include an internal combustion engine, a fuel cell, and the like. The working fluid may air, hydrogen, nitrogen, and the like. The working fluid is typically compressed when delivered to the system, as described in further detail below.

The rotating machine 30 includes a compressor housing 32 defining a compressor housing interior 34 extending between a first compressor housing end 36 and a second compressor housing end 38. The compressor housing 32 partially defines a flow path 40 fluidly coupled to the compressor housing interior 34 for directing the working fluid to the system through the flow path 40. The compressor housing 32 extends along a compressor housing axis CA between the first and second compressor housing ends 36, 38.

The rotating machine 30 also includes a shaft 44 extending along a shaft axis SA parallel with the compressor housing axis CA. The shaft axis SA may correspond to the compressor housing axis CA. The rotating machine 30 further includes a compressor wheel 48 disposed in the compressor housing interior 34. The compressor wheel 48 is coupled to the shaft 44 and rotatable by the shaft 44 about the shaft axis SA. The compressor wheel 48 has an inducer 50 adjacent the first compressor housing end 36 and an exducer 52 adjacent the second compressor housing end 38. The exducer 52 of the compressor wheel 48 is configured to deliver the working fluid from the compressor housing interior 34 to the flow path 40 during rotation of the compressor wheel 48 about the shaft axis SA.

In some embodiments, as shown in FIG. 1B, the turbocharger 70 includes a turbine housing 72 defining a turbine housing interior 74, and a turbine wheel 76 disposed within the turbine housing interior 74 for receiving exhaust gas from an internal combustion engine, with the shaft 44 being coupled to and rotatable by the turbine wheel 76. In such embodiments, during rotation of the turbine wheel 76 from exhaust gas, the shaft 44 rotates and, in turn, rotates the compressor wheel 48.

The rotating machine 30 further includes a backplate 54 coupled to the compressor housing 32. The backplate 54 further defines the flow path 40. Typically, the flow path 40 is further defined as a diffuser 64 for reducing the velocity of the working fluid and increasing pressure of the working fluid for delivery to the system, such as an internal combustion engine or fuel cell. The backplate 54 and the compressor housing 32 are configured to direct working fluid from the compressor housing interior 34 through the flow path 40. The backplate 54 defines a working fluid connection 56 adjacent the compressor wheel 48 and/or flow path 40, and the working fluid connection 56 is fluidly coupled to the flow path 40 for directing working fluid to the compressor wheel 48 and/or flow path 40 such that the compressor wheel 48 delivers working fluid from the compressor housing interior 34 and the working fluid connection 56 to the flow path 40. In other words, the working fluid connection 56 may be adjacent the compressor wheel 48 and, in some embodiments, the exducer 52 of the compressor wheel 48. Additionally, the working fluid connection 56 may be adjacent the flow path 40, in other words downstream of the compressor wheel 42, for directing the working fluid into the flow path 40. The working fluid connection 56 may be defined at least 180 degrees about the shaft axis SA in some embodiments. In other embodiments, the working fluid connection 56 is defined 360 degrees about the shaft axis SA. It is to be appreciated that the backplate 54 may define multiple working fluid connections 56 about the shaft axis SA.

Having the backplate 54 defining the working fluid connection 56 adjacent the compressor wheel 48 and/or fluid path 40 provides compressor wheel 48 with additional working fluid to compress through the flow path 40, which helps with the efficiency and performance of the rotating machine 30. Specifically, depending on various parameters of the rotating machine 30, such as size of the compressor wheel 48, the working fluid connection 56 may be adjusted in size or location. Specifically, the working fluid connection 56 may be adjusted such that sufficient working fluid is provided to the compressor wheel 48 to improve the surge line location and to improve efficiency in certain portions of the compressor map. Additionally, as described in further detail below, the working fluid flow through the working fluid connection 56 may be changed and controlled based on desired performance parameters of the device, such as an internal combustion engine or fuel cell, utilizing a working fluid.

With reference to FIG. 1A-3, the backplate 54 may define a backplate volute 58 fluidly coupled to the flow path 40 and the working fluid connection 56. The backplate volute 58 recirculates a portion of working fluid delivered through the flow path 40 from the compressor wheel 48. When recirculating a portion of working fluid delivered through the flow path 40 from the compressor wheel, the recirculated portion of working fluid, commonly referred to as mass flow recirculation (MFR), flows through the backplate volute 58 and then through the working fluid connection 56 to be directed through the flow path 40. It is to be appreciated that the backplate volute 58 may passively recirculate the recirculated working fluid flow 106 to the working fluid connection 56. In other words, when passively recirculating the recirculated working fluid flow 106, the rotating machine 30 is free of valves or external controls that change the mass flow of the recirculated working fluid flow 106 through the backplate volute 58. In such embodiments, the desired MFR may be achieved by modifying the flow configuration of the backplate volute 58, such as adding a restrictive pipe or orifice, that is static and does not change based on performance metrics of the rotating machine 30. In other embodiments, as described below, the backplate volute 58 may actively recirculate the recirculated working fluid flow 106 to the working fluid connection 56.

The rotating machine 30 may include a valve 60. The valve 60 may be coupled to the compressor housing 32, the backplate 54, and or another component of the rotating machine 30. Typically, the valve 60 is placed upstream of a backplate volute inlet 82, as described in further detail below. The valve 60 may also be placed upstream of the backplate volute inlet 83. The valve 60 is shown as being coupled to a component of the rotating machine 30, such as the compressor housing 32 or backplate 54, in FIG. 9. The valve 60 may be moveable between a first position for blocking working fluid flow from flowing to and/or from the backplate volute 58, through the working fluid connection 56, and into the flow path 40, and a second position for allowing working fluid flow to flow to and/or from the backplate volute 58, through the working fluid connection 56, and into the flow path 40. The valve 60 may be moveable to any number of positions, such as an intermediate position, for restricting working fluid flow from flowing to and/or from the backplate volute 58, through the air connection 56, and into the flow path 40. Adjusting the working fluid flow through the backplate volute 58, through the working fluid connection 56, and into the flow path 40 allows the working fluid flow through the flow path 40 to be optimized based on the desired performance condition of the rotating machine 30. With continued reference to FIG. 9, the rotating machine 30 may include a second valve 62 coupled to the compressor housing 32, the backplate 54, and or another component of the rotating machine 30. The second valve 62 may be moveable between a first position for blocking working fluid flow from flowing to and/or from the backplate volute 58, through the working fluid connection 56, and into the flow path 40, and a second position for allowing working fluid flow to flow to and/or from the backplate volute 58, through the working fluid connection 56, and into the flow path 40. The second valve 62 may be moveable to any number of positions, such as an intermediate position, for restricting working fluid flow from flowing to and/or from the backplate volute 58, through the working fluid connection 56, and into the flow path 40. When present, the valve 60 and, when also present, the second valve 62, may be moveable between various positions for allowing, restricting, and blocking working fluid from flowing to and/or from the backplate volute 58 depending on various performance conditions of the system, such as an internal combustion engine or fuel cell, utilizing the working fluid. It is to be appreciated that the rotating machine 30 may have no valves and may also have any number of valves to regulate the flow of working fluid through the backplate volute, such as three, four, five, six, etc. valves. It is also to be appreciated that the valves may be any suitable valve, such as an open/close valve, butterfly, a continuously variable valve, and the like.

The compressor housing 32, as shown in FIGS. 1A and 1B, may define a recirculation cavity 66 about the shaft axis SA and may define a compressor housing bleed slot 68 for allowing working fluid to flow into and out, such as radially into and out, of the compressor housing interior with respect the shaft axis SA, and flow into and out, such as radially into and out, of the recirculation cavity with respect to the shaft axis SA.

As shown in FIGS. 1A and 1B, working fluid flow 104 is shown entering into the compressor housing interior 34. The compressor wheel 48 compresses the fresh working fluid flow 104 along blades of the compressor wheel 48. The working fluid flow 104 exits the compressor wheel 48 at the exducer 52, typically in proximity to the working fluid connection 56. Simultaneously, a recirculated working fluid flow 106 may be provided via the backplate volute 58 to the compressor wheel 48 at the working fluid connection 56. The working fluid flow 104 is combined with the recirculated working fluid flow 106 at the working fluid connection 56 to form combined air flow 107. The combined working fluid flow may then proceed through the flow path 40 to the system, such as an internal combustion engine or fuel cell, and/or recirculate through the backplate volute 58 back to the working fluid connection 56.

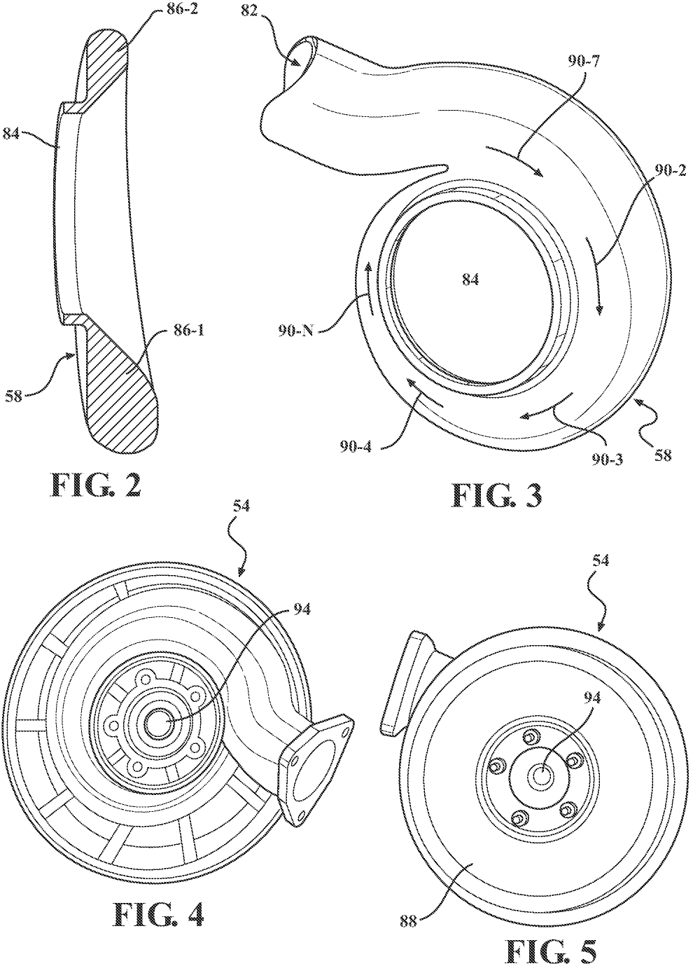

With reference to FIGS. 2 and 3, FIG. 2 is a cross-sectional view of the backplate volute 58, and FIG. 3 is a perspective view of the backplate volute 58. As described above, the backplate volute 58 may be used to provide working fluid flow, specifically recirculated working fluid flow 106, to be mixed with the working fluid flow 104, from the compressor housing interior 34 for introduction to the system, such as an internal combustion engine or fuel cell. For example, the backplate volute 58 may provide the recirculated working fluid flow 106 at the working fluid connection 56 of FIG. 1 in proximity to the compressor wheel 48 and/or flow path 40, and in some embodiments may provide the recirculated working fluid flow 106 at the working fluid connection 56 in the proximity to the exducer 52 of the compressor wheel 48.

With continued reference to FIG. 3, the backplate volute 58 includes a backplate volute inlet 82 and a backplate volute outlet 84. A backplate flow path 90 through the backplate volute 58 may realize a decreasing cross-sectional area progression 86. In some embodiments, the decreasing cross-sectional area progression 86 exhibits a linear, or near-linear, decreasing cross-sectional area progression 86 over a portion of the backplate flow path 90 from the backplate volute inlet 82 to the backplate volute outlet 84. Thus, as working fluid flows through the backplate volute 58, it realizes decreased area as indicated by cross-sectional area progressions 86.

For example, the area 86-1 at the bottom of FIG. 2 depicts a representative cross section of the backplate volute 58 near the backplate volute inlet 82 (e.g., near the position 90-1 along the spiral shaped flow path 40). The area 86-2 at the top of the FIG. 2 depicts a representative cross section of the backplate volute at a position further along the backplate flow path 90 from the backplate volute inlet 82 (e.g., near the position 90-4) and presents a smaller cross-sectional area than does the area 86-1. As working fluid flow proceeds from the backplate volute inlet 82 towards the backplate volute outlet 84 along the backplate flow path 90 (e.g., 90-1, 90-2, . . . 90-N) it experiences a smaller cross-sectional area as it exits the backplate volute outlet 84. The backplate volute outlet 84 provides for an introduction of working fluid (i.e., through recirculated working fluid flow 106) to the compressor wheel 48 and/or flow path 40, and in this case a trailing edge of the compressor wheel 48, along a circumference of the compressor wheel 48.

FIG. 4 shows the perspective view of the backplate volute 58, and FIG. 5 shows another perspective view backplate volute 58. The backplate 54 typically includes an opening 94 for the shaft 44. The backplate volute 58 also includes a diffuser face 88 which partially defines the flow path 40.

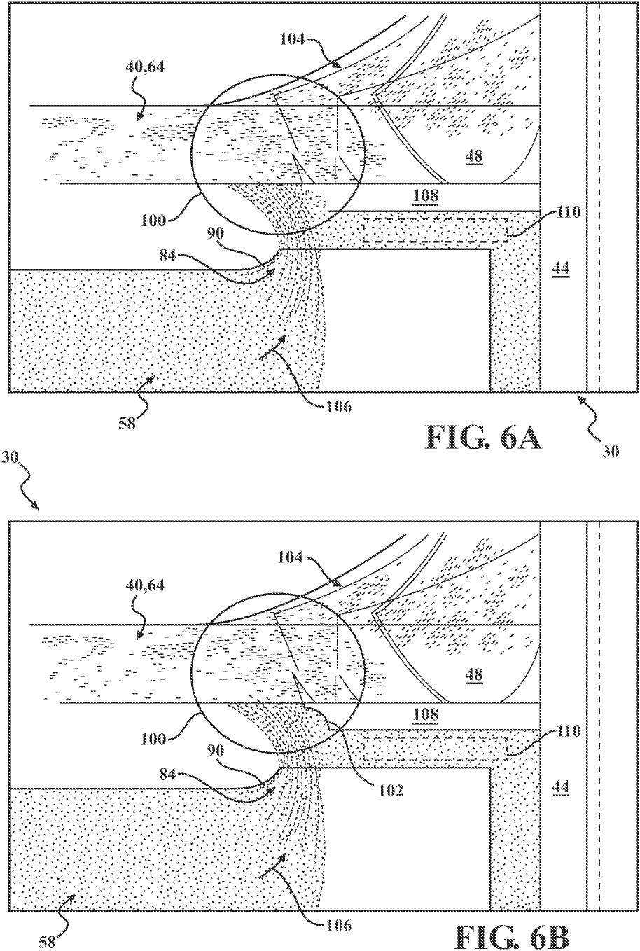

FIG. 6A shows a cross-sectional view of a junction area 100 the working fluid flow 104 and the recirculated working fluid flow 106. The junction area 100 is where the working fluid flow 104 combines with the recirculated working fluid flow 106. The second working fluid flow 106 is provided via the backplate volute outlet 84 of the backplate volute 58. The working fluid flow 104 is provided via the rotating blades (which are typically integral with a hub of the compressor wheel) of the compressor wheel 48. The working fluid flow 104 combines with the recirculated working fluid flow 106 and proceeds through the flow path 40 (diffuser 64) to be introduced to the system, such as an internal combustion engine or fuel cell. While a majority of the recirculated working fluid flow 106 is typically provided to the junction area 100, a portion of the recirculated working fluid flow 106 may be directed, by the backplate volute outlet 84, towards a back surface 108 of the compressor wheel 48. This portion of the recirculated working fluid flow 106 directed towards the back surface 108 of the compressor wheel 48 provides a pressure towards a compressor wheel pocket 110 and may provide for improved sealing along the shaft 44. The recirculated working fluid flow 106 directed to the compressor wheel pocket 110 may provide for increased pressure along the back surface 108 of the compressor wheel 48, which increases a pressure differential across oil seals disposed around the shaft 44. This increased pressure differential aids in reducing an amount of oil that may leak past seals disposed between the compressor wheel 48 and a bearing compartment, thereby limiting an amount of oil being introduced to the intake tract via the compressor wheel pocket 110. The amount of flow directed towards the back surface 108 may be adjusted based at least in part on a degree of overlap provided by the backplate volute outlet 84 towards the back surface 108 as compared to the portion of recirculated working fluid flow 106 provided to the junction area 100.

FIG. 6B depicts the cross-sectional view of the junction area 100 of FIG. 6A, except in FIG. 6B, the compressor wheel 48 includes the back surface 108 that produces the compressor wheel pocket 110 with a shaped edge 102, such as scalloped edge, curved, chamfered, and the like. The scalloped edge 102 directs a portion of the backplate volute flow towards the junction area 100 to align the recirculated working fluid flow 106 with the working fluid flow 104.

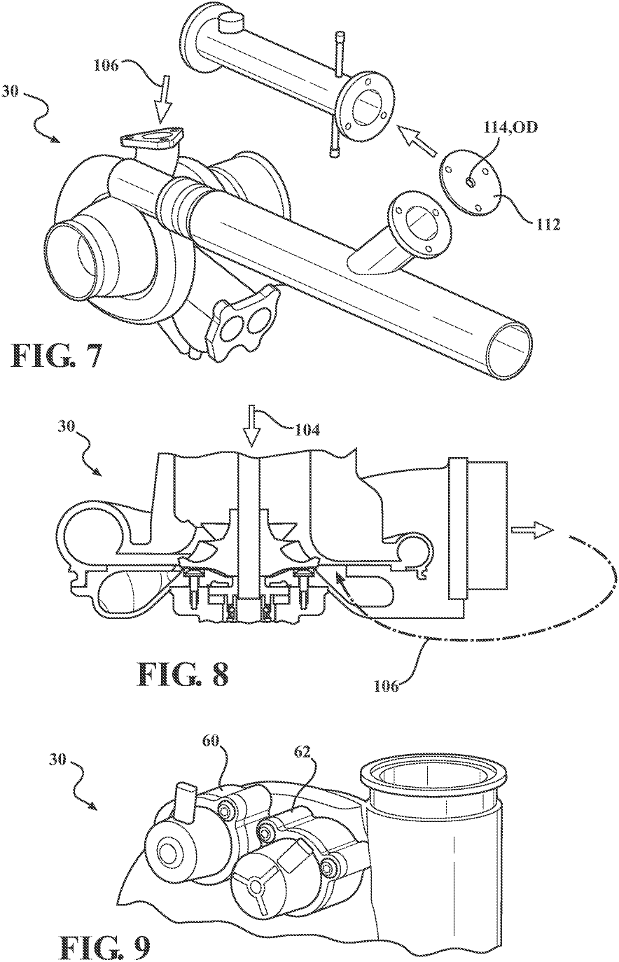

FIGS. 7 and 8 show additional views of the rotating machine 30. In particular, FIG. 7 illustrates a test set-up of the rotating machine 30 in which an orifice plate 114 defining an orifice 114 is used to regulate the working fluid flowing into and out of the backplate volute 58 and through the working fluid connection 56, and FIG. 8 indicates the general flow path of working fluid during the test set-up of FIG. 7. It is to be appreciated that the orifice plate 114, or a similar component defining an orifice, may be placed in any suitable location to regulate the recirculated working fluid flow 106 during operation of the rotating machine 30.

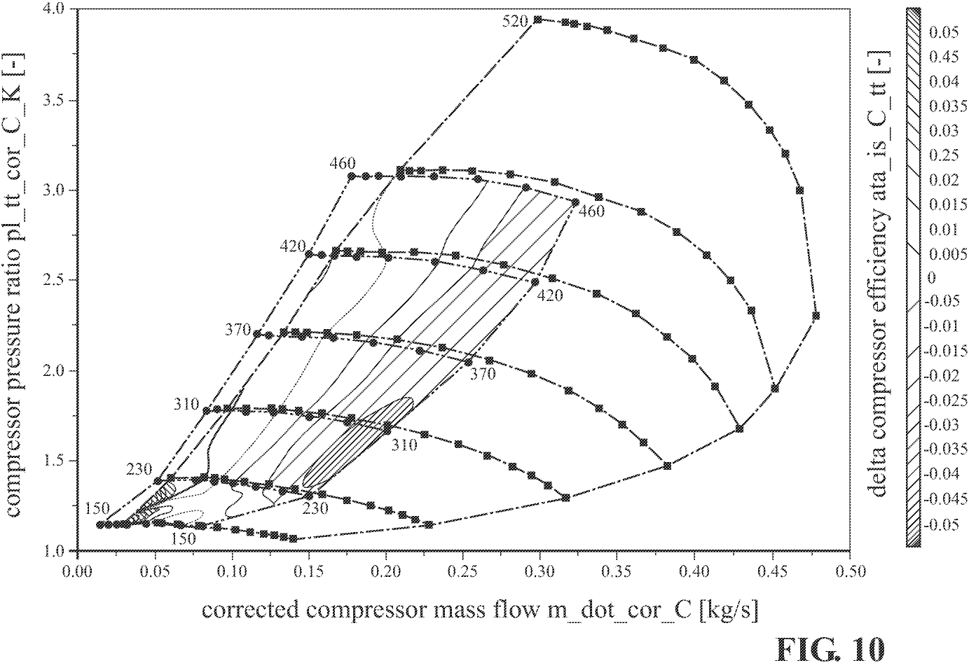

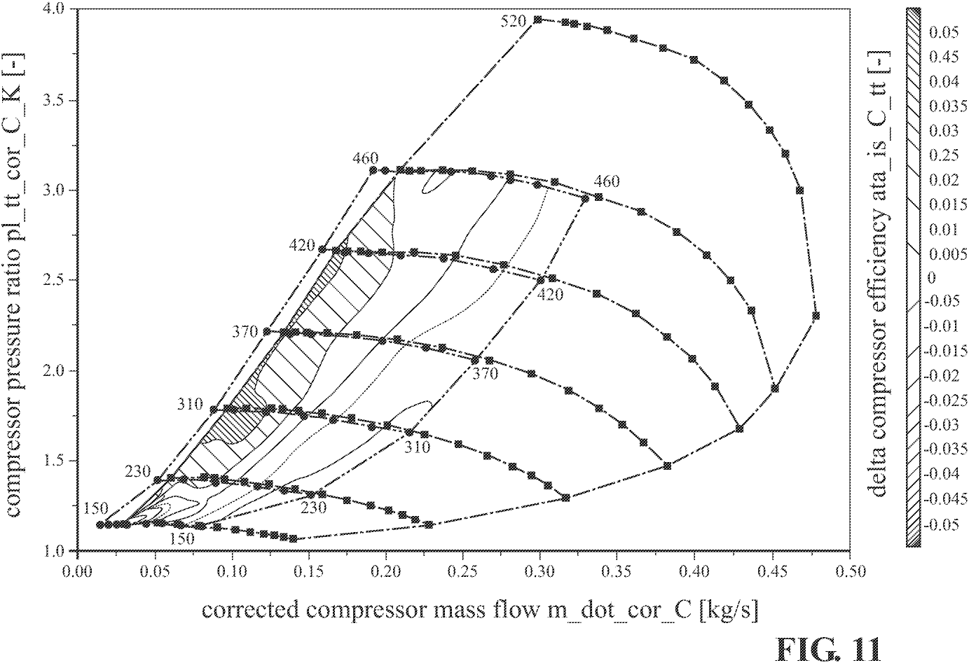

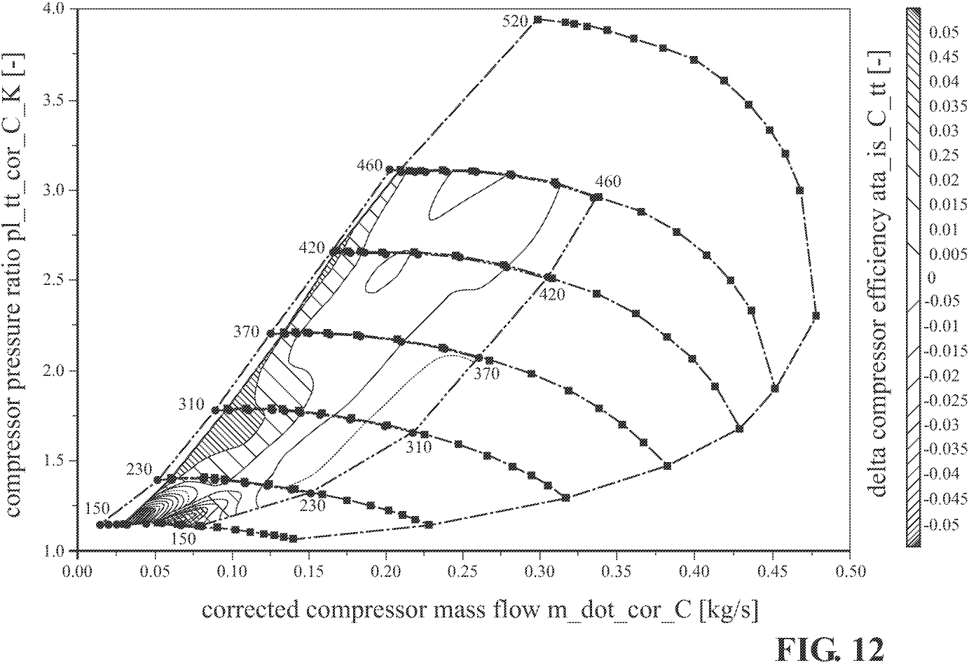

Three different graphical illustrations of the performance of the rotating machine 30 are shown in FIGS. 10-12. In particular, FIG. 10 represents an orifice 114 having a first diameter, FIG. 11 represents an orifice 114 having a second diameter less than the first diameter, and FIG. 12 represents an orifice 114 having a third diameter less than the second diameter. Each of FIGS. 10-12 represent performance and efficiency of the rotating machine 30 based on the different orifice 114 size. All three tests indicated by FIGS. 10-12 used the same rotating machine, and only the orifice 114 was modified between all three tests. In each of FIGS. 10-12, the circle outlined map is with mass flow recirculation (MFR; i.e., working fluid flowing through the working fluid connection 56 to the exducer 52 of the compressor wheel 48), and the square outlined map is a reference map without MFR. The cross-hatching slanted from the upper left to bottom right of the graph of FIGS. 10-12 indicate areas of the map using MFR that have higher efficiency than the white and areas of the map having cross-hatching slanted from the bottom left to upper right. As shown in FIGS. 10-12, there was a surge line improvement as the size of the orifice decreased from FIG. 10 to FIG. 11 and to FIG. 12.

The orifice 114 may define an orifice diameter OD, and the compressor wheel 48 may have a compressor wheel diameter CD (double the compressor wheel 48 radius, CR, as shown in FIGS. 1 and 2). In one embodiment, the orifice diameter OD is between 1% and 30% of the compressor wheel diameter CD. In another embodiment, the orifice diameter OD is between 1% and 25% of the compressor wheel diameter CD. In another embodiment, the orifice diameter OD is between 1% and 20% of the compressor wheel diameter CD. In another embodiment, the orifice diameter OD is between 1% and 15% of the compressor wheel diameter CD. In another embodiment, the orifice diameter OD is between 1% and 12% of the compressor wheel diameter CD. In another embodiment, the orifice diameter OD is between 1% and 10% of the compressor wheel diameter CD. In another embodiment, the orifice diameter OD is between 1% and 8% of the compressor wheel diameter CD. In another embodiment, the orifice diameter OD is between 1% and 5% of the compressor wheel diameter CD. In another embodiment, the orifice diameter OD is between 3% and 5% of the compressor wheel diameter CD, which is the orifice diameter OD tested and results shown in FIG. 12. In another embodiment, the orifice diameter OD is between 6% and 8% of the compressor wheel diameter CD, which is the orifice diameter OD tested and results shown in FIG. 11. In another embodiment, the orifice diameter OD is between 9% and 11% of the compressor wheel diameter CD, which is the orifice diameter OD tested and results shown in FIG. 10.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A rotating machine for delivering a working fluid to a system, said rotating machine comprising:
a compressor housing defining a compressor housing interior extending between a first compressor housing end and a second compressor housing end, with said compressor housing partially defining a flow path fluidly coupled to said compressor housing interior for directing working fluid to system through said flow path, and with said compressor housing extending along a compressor housing axis between said first and second compressor housing ends;
a shaft extending along a shaft axis parallel with said compressor housing axis;
a compressor wheel disposed in said compressor housing interior, with said compressor wheel being coupled to said shaft and rotatable by said shaft about said shaft axis, with said compressor wheel having an inducer adjacent said first compressor housing end and an exducer adjacent said second compressor housing end, and with said exducer of said compressor wheel being configured to deliver working fluid from said compressor housing interior to said flow path during rotation of said compressor wheel about said shaft axis;
a backplate coupled to said compressor housing and further defining said flow path, wherein said backplate and said compressor housing are configured to direct working fluid from said compressor housing interior through said flow path; and,
wherein said backplate defines a working fluid connection adjacent said compressor wheel and/or said flow path such that said working fluid connection is fluidly coupled to said flow path and such that said compressor wheel delivers working fluid from said compressor housing interior and said working fluid connection to said flow path.

2. The rotating machine as set forth in claim 1, wherein said backplate defines a backplate volute fluidly coupled to said flow path and said working fluid connection, wherein backplate volute recirculates a portion of working fluid delivered to said flow path from said compressor wheel, through said working fluid connection, and back into said flow path.

3. The rotating machine as set forth in claim 1, further comprising a valve moveable between a first position for blocking working fluid flow from flowing through said backplate volute, through said working fluid connection, and into said flow path, and a second position for allowing working fluid flow to flow through said backplate volute, through said working fluid connection, and into said flow path.

4. The rotating machine as set forth in claim 3, wherein said valve is moveable to an intermediate position for restricting working fluid flow from flowing through said backplate volute, through said working fluid connection, and into said flow path.

5. The rotating machine as set forth in claim 3, further comprising a second valve moveable between a first position for blocking working fluid flow from flowing through said backplate volute, through said working fluid connection, and into said flow path, and a second position for allowing working fluid flow to flow through said backplate volute, through said working fluid connection, and into said flow path.

6. The rotating machine as set forth in claim 5, wherein said second valve moveable to an intermediate position for restricting working fluid flow from flowing through said backplate volute, through said working fluid connection, and into said flow path.

7. The rotating machine as set forth in claim 1, wherein said flow path defined by said compressor housing and said backplate is further defined as a diffuser.

8. The rotating machine as set forth in claim 1, wherein said working fluid connection is defined at least 180 degrees about said shaft axis.

9. The rotating machine as set forth in claim 8, wherein said working fluid connection is defined 360 degrees about said shaft axis.

10. The rotating machine as set forth in claim 1, wherein said compressor housing defines a recirculation cavity about said shaft axis and defines a compressor housing bleed slot for allowing working fluid to radially flow into and out of said compressor housing interior with respect said shaft axis, and flow radially into and out of said recirculation cavity with respect to said shaft axis.

11. A system comprising said rotating machine as set forth in claim 1, and further comprising a fuel cell, wherein said flow path is configured to direct working fluid to said fuel cell.

12. A turbocharger for delivering a working fluid to a system, said turbocharger comprising:
a compressor housing defining a compressor housing interior extending between a first compressor housing end and a second compressor housing end, with said compressor housing partially defining a flow path fluidly coupled to said compressor housing interior for directing working fluid to the system through said flow path, and with said compressor housing extending along a compressor housing axis between said first and second compressor housing ends;
a shaft extending along a shaft axis parallel with said compressor housing axis;
a compressor wheel disposed in said compressor housing interior, with said compressor wheel being coupled to said shaft and rotatable by said shaft about said shaft axis, with said compressor wheel having an inducer adjacent said first compressor housing end and an exducer adjacent said second compressor housing end, and with said exducer of said compressor wheel being configured to deliver working fluid from said compressor housing interior to said flow path during rotation of said compressor wheel about said shaft axis;
a backplate coupled to said compressor housing and further defining said flow path, wherein said backplate and said compressor housing are configured to direct working fluid from said compressor housing interior through said flow path;
a turbine housing defining a turbine housing interior;
a turbine wheel disposed within said turbine housing interior for receiving the exhaust gas from the system, with said shaft being coupled to and rotatable by said turbine wheel; and,
wherein said backplate defines a working fluid connection adjacent said compressor wheel and/or said flow path such that said working fluid connection is fluidly coupled to said flow path and such that said compressor wheel delivers working fluid from said compressor housing interior and said working fluid connection to said flow path.

13. The turbocharger as set forth in claim 12, wherein said backplate defines a backplate volute fluidly coupled to said flow path and said working fluid connection, wherein backplate volute recirculates a portion of working fluid delivered to said flow path from said compressor wheel, through said working fluid connection, and back into said flow path.

14. The turbocharger as set forth in claim 12, further comprising a valve moveable between a first position for blocking working fluid flow from flowing through said backplate volute, through said working fluid connection, and into said flow path, and a second position for allowing working fluid flow to flow through said backplate volute, through said working fluid connection, and into said flow path.

15. The turbocharger as set forth in claim 14, wherein said valve is moveable to an intermediate position for restricting working fluid flow from flowing through said backplate volute, through said working fluid connection, and into said flow path.

16. The rotating machine as set forth in claim 12, wherein said working fluid connection is defined at least 180 degrees about said shaft axis.

17. The rotating machine as set forth in claim 12, wherein said compressor housing defines a recirculation cavity about said shaft axis and defines a compressor housing bleed slot for allowing working fluid to radially flow into and out of said compressor housing interior with respect said shaft axis, and flow radially into and out of said recirculation cavity with respect to said shaft axis.

18. A system, comprising:
an internal combustion engine; and
a rotating machine for delivering a working fluid to said internal combustion engine, wherein said rotating machine comprises,
a compressor housing defining a compressor housing interior extending between a first compressor housing end and a second compressor housing end, with said compressor housing partially defining a flow path fluidly coupled to said compressor housing interior for directing working fluid to said internal combustion engine through said flow path, and with said compressor housing extending along a compressor housing axis between said first and second compressor housing ends,
a shaft extending along a shaft axis parallel with said compressor housing axis,
a compressor wheel disposed in said compressor housing interior, with said compressor wheel being coupled to said shaft and rotatable by said shaft about said shaft axis, with said compressor wheel having an inducer adjacent said first compressor housing end and an exducer adjacent said second compressor housing end, and with said exducer of said compressor wheel being configured to deliver working fluid from said compressor housing interior to said flow path during rotation of said compressor wheel about said shaft axis,
a backplate coupled to said compressor housing and further defining said flow path,
wherein said backplate and said compressor housing are configured to direct working fluid from said compressor housing interior through said flow path; and
wherein said backplate defines a working fluid connection adjacent said compressor wheel and/or said flow path such that said working fluid connection is fluidly coupled to said flow path and such that said compressor wheel delivers working fluid from said compressor housing interior and said working fluid connection to said flow path.

19. The system as set forth in claim 18, wherein said rotating machine is further defined as a turbocharger, and wherein said turbocharger comprises a turbine housing defining a turbine housing interior, and a turbine wheel disposed within said turbine housing interior for receiving the exhaust gas from said internal combustion engine, with said shaft being coupled to and rotatable by said turbine wheel.

20. The system as set forth in claim 18, wherein said backplate defines a backplate volute fluidly coupled to said flow path and said working fluid connection, wherein backplate volute recirculates a portion of working fluid delivered to said flow path from said compressor wheel, through said working fluid connection, and back into said flow path.
